(19) United States
(12) Patent Application Publication
(10) Pub. No.: US 2006/0022788 A1
(43) Pub. Date: Feb. 2, 2006

(54) Surface mount coil component

(75) Inventors: Kunio G. Sasamori, Tsurugashima-Shi (JP); Koichiro Hyodo, Tsurugashima-Shi (JP)

Correspondence Address: RENNER, KENNER, GREIVE, BOBAK, TAYLOR & WEBER;Fourth Floor, First National Tower, Akron, OH, 44308-1456, US

(73) Assignee: Toko Kabushiki Kaisha

(21) Appl. No.: 11/193,596

(22) Filed: Jul. 29, 2005

(30) Foreign Application Priority Data
Jul. 30, 2004 (JP) 2004-222940

(51) Int. Cl. H01F 27/30

(52) U.S. Cl. 336/208

(57) ABSTRACT

An object is to provide a highly reliable surface mount coil component quickly and reliably forming thermo-compression bonding on an occasion of thermo-compression bonding by a heater chip, and reliably fixing the metal plate terminal, in a surface mount coil component having thermo-compression bonding of a winding wire and a metal plate terminal. In a surface mount coil component including a winding wire 2, a core 1 and a metal plate terminal 3, the metal plate terminal 3 integrally includes a fixing part 3b which is bonded and fixed to the core 1, a joint part 3a to which an end of the winding wire is bonded by thermo-compression bonding, and a mount part 3c which is connected to an external circuit, the fixing part 3c is integrally included between the joint part 3a and the mount part 3b, and a sectional reduced portion 5 is formed between the joint part 3a and the fixing part 3b.

### BACKGROUND OF THE INVENTION

1. Field of the Invention

The present invention relates to a surface mount coil component, and particularly relates to a structure of a metal plate terminal to which an end of a winding wire is connected.

2. Related Art

Conventionally, as a coil component used in a compact electronic device, for example, the one shown in FIGS. 6A and 6B is cited. This is formed by fixing with an adhesive 27 a drum core 21 made of a magnetic substance which has a winding core part 21a and flange parts 21b and 21b provided integrally with the winding core part 21a, a winding wire 22 which is formed by winding an insulating coating conducting wire around the winding core part 21a of the drum core 21, and a cylindrical ring core 24 made of a magnetic substance disposed at an outer periphery of the drum core 21 around which the winding wire 22 is wound with a space from the outer periphery of the drum core 21, as an inductance element 40 shown in a top view (FIG. 6A) and a sectional view (FIG. 6B).

The metal plate terminal 23 extends from a bottom surface part 23c to a side surface part 23b and a top surface part 23a along an outer surface of the ring core 24, the top surface part 23a is a joint part with an end 22a of the winding wire 22, and the bottom surface part 23c is a mount part connecting to an external circuit.

As described above, the metal plate terminal 23 has a section in a horseshoe shape, and is fixed with an adhesive 26 with the side surface part 23b as a fixing part to the ring core 24. An inductance element with the structure in which the ends 22a and 22a of the winding wire 22 are led out to the joint parts 23a and 23a of the metal plate terminal 23 and electrically connected is shown in Japanese Patent Laid-open No. 10-294221, for example.

The inductance element 40 as described above is made by winding an insulating covering conductor wire as the winding wire 22 around the winding core part 21a of the drum core 21, thereafter, housing the drum core 21 into the ring core 24 to which the metal plate terminal 23 is bonded and fixed, and fixing a lower flange part 21b of the drum core 21 with an adhesive 27. The ends 22a and 22a of the winding wire 22 are led out onto the joint parts 23a and 23a of the metal plate terminal 23, and are electrically connected by soldering, laser or the like and thermo-compression bonding.

Note that when the surface mount coil component uses reflow soldering by an atmosphere furnace, thermo-compression bonding is suitable, considering solder melting at the joint part by reflow heat.

In the thermo-compression bonding, it is necessary to joint the insulating coating conductive wire firmly to the metal plate terminal by breaking and removing an insulating coating film of the insulating coating conductor wire made of a polyurethane resin, a polyester resin or the like at the same time, and therefore, for example, in the case of the inductance element 40, a pressing surface 8 (heated to 400° C. to 900° C.) at a tip end of a heater chip 7 is pressed against the end 22a of the winding wire 22, and has to be heated and pressurized for a long time as shown in FIG. 7.

In this case, as the metal plate terminal material, an electrically conductive material with high thermal conductivity such as phosphor bronze to which Sn—Cu plating is applied is used, and since a heat quantity by which the end 22a is heated by the heater chip 7 is transmitted to the fixed part 23b bonded and fixed and the mount part 23c from the joint part 23a of the metal plate terminal, thermal deterioration of the adhesive 26 which bonds and fixes the ring core and the metal plate terminal occurs, thus causing the problem of reducing the bonding strength and peeling the adhesive.

When the applied heat disperses and a sufficient heat quantity required for thermo-compression bonding cannot be obtained, if more heating time and pressurization than necessary are applied by the heater chip, more heat is applied to the fixed part. Therefore, thermal deterioration of the adhesive is accelerated, and the life of the heater chip is shortened. Further, depending on the heat quantity, the mount part surface of the metal plate terminal connected to the external circuit causes thermal oxidation, which causes the serious problem of lowering solderability to substrate solder.

### SUMMARY OF THE INVENTION

The present invention is made in view of the above-described problems, and has its object to provide a highly reliable surface mount coil component which quickly and reliably forms thermo-compression bonding on an occasion of thermal-compression bonding by a heater chip and ensures fixing of metal plate terminals.

In view of the above-described problems, the present invention is, in a surface mount coil component including a winding wire, a core and a metal plate terminal, characterized in that the metal plate terminal integrally includes a fixing part which is bonded and fixed to the core, a joint part to which an end of the winding wire is bonded by thermo-compression bonding, and a mount part which is connected to an external circuit, the fixing part is integrally included between the joint part and the mount part, and a sectional reduced portion is formed between the joint part and the fixing part.

The present invention is, in a surface mount coil component including a core including a winding core part around which a winding wire is wound, and flanges at both ends of the winding core part, and a metal plate terminals at the flanges, with ends of the winding wire connected to the metal plate terminals, characterized in that the metal plate terminal integrally includes a fixing part which is bonded and fixed to the core, a joint part to which the end of the winding wire is bonded by thermo-compression bonding, a mount part which is connected to an external circuit, the fixed part is integrally included between the joint part and the mount part, a sectional reduced portion is formed between the joint part and the fixing part.

The present invention is, in a surface mount coil component comprising a core including a winding core part around which a winding wire is wound, and flanges at both ends of the winding core part, a ring core disposed in close vicinity of the flanges and metal plate terminals at the ring core, with ends of the winding wire connected to the metal plate terminals, characterized in that the metal plate terminal integrally includes a fixing part which is bonded and fixed to the core, a joint part to which the end of the winding wire is bonded by thermo-compression bonding, a mount part which is connected to an external circuit, the fixed part is integrally included between the joint part and the mount part, a sectional reduced portion is formed between the joint part and the fixing part.

The metal plate terminal is provided with a folded portion between the joint part and the fixing part, and the sectional reduced portion is formed in the folded part. Further, the sectional reduced portion is characterized by being provided with at least one hole or more, or one notch or more, or provided with at least one hole or more and at least one notch or more. Furthermore, the present invention is characterized in that as for the winding wire, an insulating coating conductive wire circular in section or an insulating coating conductive wire rectangular in section is used.

The surface mount coil component of the present invention includes the core including the winding wire, and the metal plate terminal which connects the end of the winding wire. By using the metal plate terminal integrally provided with the joint part to which the wiring wire is bonded by thermo-compression bonding, the mount part which is connected to the external circuit, with the fixing part integrally provided between the joint part and the mount part, and with the sectional reduced portion formed between the joint part and the fixing part, high heat at the time of bonding the end of the winding wire by thermo-compression bonding can be suppressed from dispersing to regions other than the joint part by heat conduction.

The heating temperature of the heater chip, which is the condition of the thermo-compression bonding can be kept without being released, and therefore, a stable set condition can be kept without performing higher thermo-compression operation than the set condition. Thus, the life of the heater chip is not shortened.

Since thermal deterioration of the adhesive which bonds and fixes the core and the metal plate terminal can be prevented, and therefore, a highly reliable surface mount coil component with reliable fixing of the metal plate terminal without peeling off without surface oxidization of the mount part can be provided.

### BRIEF DESCRIPTION OF THE DRAWINGS

FIG. 1 is a perspective view of a surface mount coil component which is a first embodiment of the present invention;

FIG. 2 is an exploded perspective view of the surface mount coil component which is the first embodiment of the present invention;

FIG. 3 is a perspective view of a surface mount coil component which is a second embodiment of the present invention;

FIG. 4A is a perspective view of a surface mount coil component which is a third embodiment of the present invention, and

FIG. 4B is a sectional view taken along the line B-B in FIG. 4A;

FIGS. 5A to 5C are views showing other shapes of sectional reduced portions of the metal plate terminal of the surface mount coil component which is the embodiment of the present invention, and FIGS. 5A to 5C are explanatory views respectively showing three different kinds of notch structures as examples;

FIG. 6A is a top view of a conventional surface mount coil component, and

FIG. 6B is a sectional view taken along the line A-A in FIG. 6A; and

FIG. 7 is a perspective view showing a state of thermo-compression bonding.

### DETAILED DESCRIPTION OF THE INVENTION

Hereinafter, an embodiment which is a mode for carrying out a surface mount coil component according to the present invention will be described with reference to the drawings.

A first embodiment of the present invention is a surface mount coil component of a construction constituted of a winding wire, a core and a metal plate terminal.

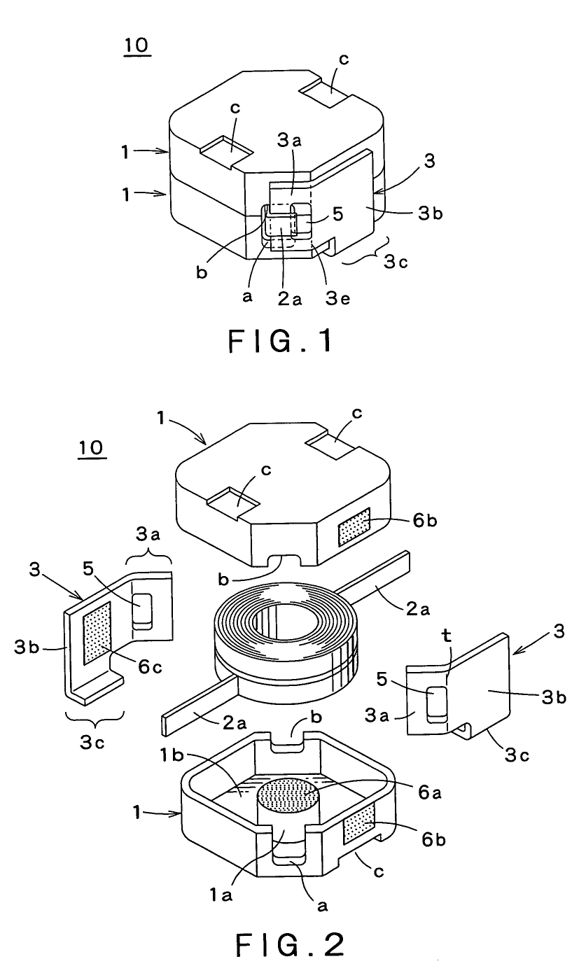

FIG. 1 is a perspective view of a surface mount coil component 10 which is the first embodiment of the present invention, and FIG. 2 is an exploded perspective view of the surface mount coil component 10 which is the first embodiment. In FIGS. 1 and 2, reference numeral 1 denotes a core, reference numeral 2 denotes a winding wire, reference numeral and character 2a denotes an end of the winding wire and reference numeral 3 denotes a metal plate terminal.

The winding wire 2 adopts a so-called flat wire rectangular in section with insulating coating treatment applied to a surface, and is an air-core coil which is formed to be a so-called outside to outside winding wire with the ends 2a and 2a led outside.

The core 1 is made of a magnetic substance, and is molded into a substantially quadrangle with an E-shaped section including a winding shaft 1a at a center and including a recessed part 1b which houses the winding wire 2. Tapers are provided at a pair of opposed corners, notches “a” and “b” are provided at openings of the tapered parts, and a pair of recessed parts “c” in which each part of the metal plate terminals 3 is placed are provided on surfaces at opposite sides from the openings.

The metal plate terminal 3 is made of a copper alloy such as phosphor bronze to which Sn—Cu plating is applied, and brass, is formed by working a thin flat plate with a fixing part 3b for bonding and fixing to a core side surface, a joint part 3a for connecting a winding wire end extensively connected to one end portion, and a mount part 3c for connecting to an external circuit extensively provided at the other end portion of the fixing part 3b located adjacently to the joint part 3a and folded in a L-shape along the recessed part “c” of the core 1. A square hole 5 which is folded at an angle along a side surface of the core, and is a sectional reduced portion with a folded part t (broken line) as a center is provided between the joint part 3a and the fixing part 3b.

Two cores 1 are opposed on the open surfaces, and the winding wire 2 is housed in the recessed parts 1b of the cores 1 and 1. As this method, one of the cores 1 is placed with the open surface up, and the ends 2a and 2a of the winding wire 2 are aligned with the notched parts “a” and “b” of the core 1, and the center part of the winding wire 2 is fitted onto the winding shaft 1a of the core 1 to be housed in the recessed part 1b.

Next, an adhesive 6a is applied to a tip end portion of the winding shaft 1a of the core 1, and another core 1 is fitted to the core 1 with the notched parts “a” and “b”, “b” and “a” and the winding shafts 1a aligned with each other and heated and fixed.

Thereafter, an adhesive is applied to a pair of side surfaces 6b and 6b of the opposed upper and lower cores 1 and 1, and the mount part 3c of the metal plate terminal is fitted into the recessed part “c” of the core 1 at the lower side. An inside 6c of the fixing part 3b and parts 6b and 6b which are side surfaces of the upper and lower cores 1 with an adhesive applied thereon are fitted to each other and fixed by heating.

Next, the ends 2a and 2a of the winding wire 2 are aligned with predetermined positions on the joint parts 3a and 3a of a pair of metal plate terminals 3, and thermo-compression bonding is performed by the heater chip 7 shown in FIG. 7 to electrically connect them. Incidentally, in order to thermally break the insulating coating of the flat wire to bond it, heating which makes the tip end temperature of the heater chip 7 about 400° C.-900° C. is required.

By providing the sectional reduced portion between the joint part and the fixing part of the metal plate terminal as described above, thermal conduction of high heat in the thermo-compression bonding is suppressed, thermal deterioration of the adhesive at the fixing part is prevented, and surface oxidation in the mount part can be prevented.

By preventing peeling off of the metal plate terminal and surface oxidation of the mount part as described above, reliability at the time of substrate mounting can be enhanced. The surface mount coil component 10 which is the first embodiment of the present invention has an outside dimension of 3 mm long and wide, 1.5 mm high, and is provided with the square hole of width of 0.6 mm×0.3 mm with respect to the width of metal plate terminal of 1 mm.

A second embodiment of the present invention is a surface mount coil component constructed by a core including a winding core part around which a winding wire is wound and flanges at both ends, and metal plate terminals.

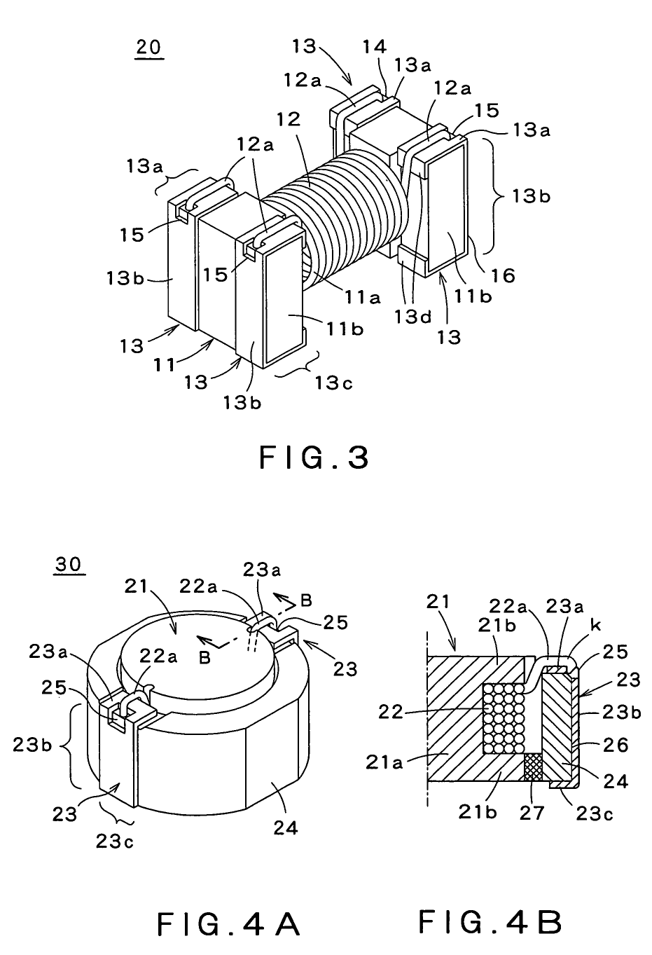

FIG. 3 is a perspective view of a surface mount coil 20 which is the second embodiment of the present invention. In FIG. 3, reference numeral 11 denotes a core, reference numeral and character 11a denotes a winding core part of the core, reference numeral 11b denotes a flange each provided at both ends of the winding core part of the core, reference numeral 12 denotes a winding wire, reference numeral and character 12a denotes an end of the winding wire, and reference numeral 13 denotes a metal plate terminal.

Here, the core 11 is a so-called drum core which is made of a magnetic substance, includes a winding core part 11a, and flanges 11b and 11b at both ends.

The metal plate terminal 13 is formed by forming a thin flat plate using a copper alloy such as bronze phosphor to which Sn—Cu plating is applied, and brass to be folded into a substantially horseshoe shape, and integrally has a top surface part 13a, a side surface part 13b, a bottom surface part 13c and upper and lower folded parts 13d.

The top surface part 13a is a joint part to which thermo-compression bonding of the end 12a of the winding wire is performed, the side surface part 13b is a fixing part for being bonded and fixed to the flange 11b of the core 11, the bottom surface part 13c is a mount part which is connected to an external circuit, and a square hole 15 which is a sectional reduced portion is provided at a folded part between the joint part 13a and the fixing part 13b. The metal plate terminal 13 is engaged with the flange 11b along the outer peripheral surface of the flange 11b of the core 11, and is heated and fixed to the side surface which is the fixing part by using the adhesive 16.

The wire 12 of plurality of windings is made by using a polyurethane wire or a polyester wire circular in section with insulating coating treatment applied to its surface for a core 11 to which the metal plate terminal 13 is bonded and fixed in advance as described above, and the ends 12a of the winding wire are respectively led out onto the joint parts 13a of the designated metal plate terminals 13, and are electrically connected by thermo-compression bonding by the heater chip 7 shown in FIG. 7.

Next, a third embodiment of the present invention is a surface mount coil component constructed by a core including a winding core part around which a winding wire is wound and flanges at its both ends, a ring core disposed in close vicinity to the flanges, and metal plate terminals, and is made by providing the metal plate terminals according to the present invention at the surface mount coil in FIGS. 6A and 6B.

FIGS. 4A and 4B show a perspective view (FIG. 4A) of a surface mount coil 30 which is the third embodiment of the present invention, and a partial sectional view (FIG. 4B) taken along the line B-B in FIG. 4A. In FIGS. 4A and 4B, the same parts as those in FIGS. 6A and 6B are assigned with the same reference numerals and characters. In FIGS. 4A and 4B, reference numeral 21 denotes a core, reference numeral and character 21a denotes a winding core part of the core, reference numeral and character 21b denotes a flange each provided at both ends of the winding core part of the core, reference numeral 22 denotes a winding wire, reference numeral and character 22a denotes an end of the winding wire, reference numeral 24 denotes a ring core, and reference numeral 23 denotes a metal plate terminal.

Here, the core 21 is a so-called drum core which is made of a magnetic substance, includes a winding core part 11a, and includes flanges 11b and 11b at both of its ends. The ring core 24 is a cylindrical core made of a magnetic substance.

The metal plate terminal 23 is formed by forming a thin flat plate using a copper alloy such as bronze phosphor to which Sn—Cu plating is applied and brass to be folded into a substantially horseshoe shape, and integrally has a top surface part 23a, a side surface part 23b and a bottom surface part 23c.

The top surface part 23a is a joint part to which the end 22a of the winding wire 22 is bonded by thermo-compression bonding, the side surface part 23b is a fixing part which is bonded and fixed to the ring core 24, the bottom surface part 23c is a mount part which is connected to an external circuit, and a square hole 25 which is a sectional reduced portion is provided at a folded portion between the joint part 23a and the fixing part 23b. The fixing part 23b of the metal plate terminal 23 is fixed to a side surface of the ring core 24 by using an adhesive 26 and heating it.

As described above, by using the ring core 24 to which the metal plate terminals 23 are bonded and fixed in advance, the winding wire 22 which is an insulating coating conductive wire wound around the winding core part 21a of the drum core 21 is housed in the ring core 24, and an outer periphery of the flange 21b which is on the bottom side of the drum core 21 and an inner periphery of the ring core 24 are fixed by using an adhesive 27 and heating it.

Then, the ends 22a and 22a of the winding wire are respectively led out on the joint parts 23a of the designated metal plate terminals 23, and after a tip end portion of each end 22a is pushed and caught in the square hole 25 of the sectional reduced portion (k portion), they are bonded by thermo-compression bonding by the heater chip 7 shown in FIG. 7 and electrically connected.

The tip end portion of the end of the winding wire is caught in the square hole of the sectional reduced portion, whereby an operational advantage of making it difficult to cause positional deviation of the end of the winding wire is provided and the effect of enhancing the welding force is provided.

In the surface mount coil component of the present invention according to the above-described embodiments, the sectional reduced portion is provided between the joint part and the fixing part of the metal terminal, and thereby, when the end of the winding wire is bonded to the metal plate terminal by thermo-compression bonding, heat conduction to the fixing part and the mount part is suppressed and thermal deterioration of the adhesive and thermal oxidation of the mount part surface are suppressed. Therefore, the present invention can provide a highly reliable surface mount coil component without peeling off the metal plate terminal or poor solderability at the time of soldering to a substrate.

As for the adhesive used in each of the embodiments, the epoxy resin adhesive with heat resistance is used.

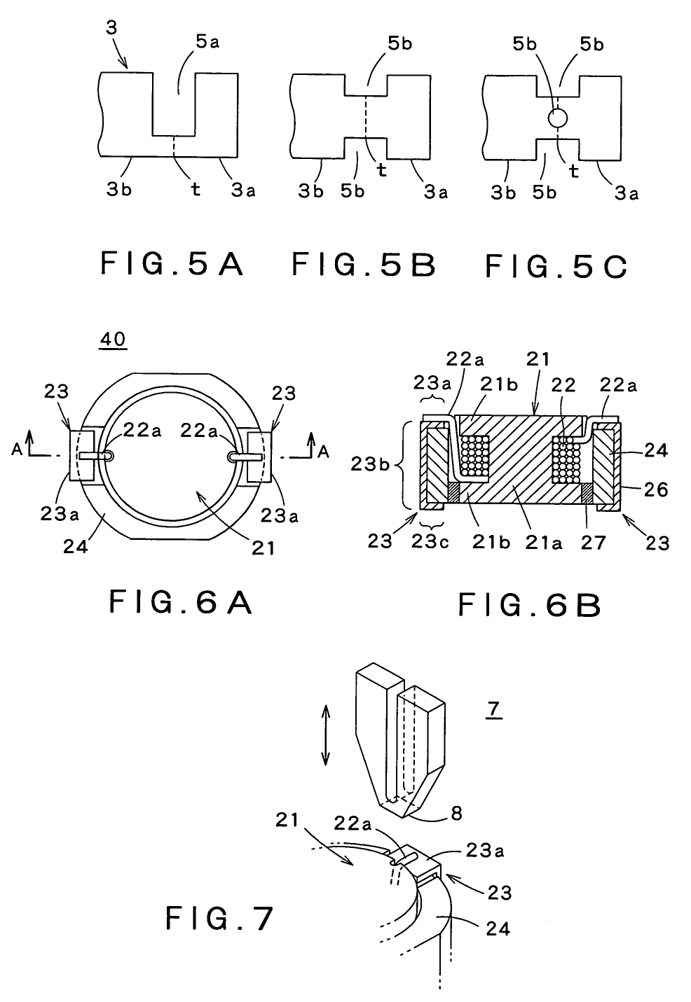

Here, other shapes of the sectional reduced portion of the metal plate terminal are shown in FIGS. 5A, 5B and 5C. In FIG. 5A, a notch 5a is provided between the joint part 3a and the fixing part 3b from one side. In FIG. 5B, notches 5b and 5b are provided between the joint part 3a and the fixing part 3b from both sides to the center axis. In FIG. 5C, the notches 5b and 5b are provided between the joint part 3a and the fixing part 3b from both sides, and a round hole 5c is provided in a central part. A dotted line portion “t” in the drawings is a border of the joint part 3a and the fixing part 3b, and with at least some folding, suppression of heat conduction is made more effective.

The size of the hole and the notch of the sectional reduced portion desirably obtain the optimal conditions in consideration of the influence on heat conduction constituted of the shape and the size of the joint part of the metal plate terminal, and the thermo-compression bonding conditions. Further, the shape of the sectional reduced portion is not limited to these embodiments, but a plurality of round holes, square holes, the holes in other shapes, notches and the like may be combined and used.

What is claimed is:

1. A surface mount coil component comprising a winding wire, a core and a metal plate terminal,
wherein said metal plate terminal integrally includes a fixing part which is bonded and fixed to said core, a joint part to which an end of said winding wire is bonded by thermo-compression bonding, and a mount part which is connected to an external circuit, the fixing part is integrally included between the joint part and the mount part, and a sectional reduced portion is formed between the joint part and the fixing part.

2. The surface mount coil component according to claim 1, wherein said metal plate terminal is provided with a folded portion between the joint part and the fixing part, and the sectional reduced portion is formed in the folded part.

3. The surface mount coil component according to claim 1, wherein the sectional reduced portion is provided with at least one hole or more, or one notch or more.

4. The surface mount coil component according to claim 1, wherein the sectional reduced portion is provided with at least one hole or more and at least one notch or more.

5. The surface mount coil component according to claim 1, wherein as for said winding wire, an insulating coating conductive wire circular in section or an insulating coating conductive wire rectangular in section is used.

6. A surface mount coil component comprising a core including a winding core part around which a winding wire is wound, and flanges at both ends of the winding core part, and a metal plate terminals at the flanges, with ends of the winding wire connected to said metal plate terminals,
wherein said metal plate terminal integrally includes a fixing part which is bonded and fixed to said core, a joint part to which the end of the winding wire is bonded by thermo-compression bonding, a mount part which is connected to an external circuit, the fixed part is integrally included between the joint part and the mount part, a sectional reduced portion is formed between the joint part and the fixing part.

7. The surface mount coil component according to claim 6, wherein said metal plate terminal is provided with a folded portion between the joint part and the fixing part, and the sectional reduced portion is formed in the folded part.

8. The surface mount coil component according to claim 6, wherein the sectional reduced portion is provided with at least one hole or more, or one notch or more.

9. The surface mount coil component according to claim 6, wherein the sectional reduced portion is provided with at least one hole or more and at least one notch or more.

10. The surface mount coil component according to claim 6, wherein as for said winding wire, an insulating coating conductive wire circular in section or an insulating coating conductive wire rectangular in section is used.

11. A surface mount coil component comprising a core including a winding core part around which a winding wire is wound, and flanges at both ends of the winding core part, a ring core disposed in close vicinity of the flanges and metal plate terminals at said ring core, with ends of the winding wire connected to said metal plate terminals,
wherein said metal plate terminal integrally includes a fixing part which is bonded and fixed to said ring core, a joint part to which the end of the winding wire is bonded by thermo-compression bonding, a mount part which is connected to an external circuit, the fixed part is integrally included between the joint part and the mount part, a sectional reduced portion is formed between the joint part and the fixing part.

12. The surface mount coil component according to claim 11, wherein said metal plate terminal is provided with a folded portion between the joint part and the fixing part, and the sectional reduced portion is formed in the folded part.

13. The surface mount coil component according to claim 11, wherein the sectional reduced portion is provided with at least one hole or more, or one notch or more.

14. The surface mount coil component according to claim 11, wherein the sectional reduced portion is provided with at least one hole or more and at least one notch or more.

15. The surface mount coil component according to claim 11, wherein as for said winding wire, an insulating coating conductive wire circular in section or an insulating coating conductive wire rectangular in section is used.
